(19) United States
(12) Patent Application Publication
(10) Pub. No.: US 2020/0410523 A1
(43) Pub. Date: Dec. 31, 2020

(54) SYSTEMS AND METHODS FOR COMMERCE AND REWARDS POINTS MANAGEMENT USING ISOLATED DATA STORAGE

(71) Applicant: Edward Showalter, Los Angeles, CA (US)

(72) Inventor: Edward Showalter, Los Angeles, CA (US)

(21) Appl. No.: 16/824,507

(22) Filed: Mar. 19, 2020

Related U.S. Application Data
(60) Provisional application No. 62/821,353, filed on Mar. 20, 2019.

(51) Int. Cl. G06Q 30/02

(52) U.S. Cl. CPC G06Q 30/0229

(57) ABSTRACT

A reward management system combined with a global e-commerce network, wherein a marketplace is provided for various merchants, retailers, and consumers, and wherein any number of participants may utilize a universal rewards system and make transactions or fund crowdfunding campaigns within a single marketplace using currency, or points and bonus points accrued via the universal rewards system, and wherein the information related to transactions that take place within the reward management system and the global e-commerce network is secured and safely, stored in an isolated data storage system that stores the information in flash drives, wherein the flash drives receive the information, and are next autonomously moved from a computer connected to the global e-commerce network to an isolated offline computer via autonomous robotic arms.

### CROSS-REFERENCE TO RELATED APPLICATIONS

This application claims the benefit of U.S. Provisional Application No. 62/821,353, filed Mar. 20, 2019, which is hereby incorporated by reference, to the extent that it is not conflicting with the present application.

### BACKGROUND OF INVENTION

### 1. Field of the Invention

The invention relates generally to commerce and e-commerce, and more particularly to rewards and loyalty programs and/or points systems associated with merchants, vendors, and other businesses.

### 2. Description of the Related Art

Many people who purchase goods or services from merchants, vendors, sellers, and other businesses may be a part of a rewards or loyalty program offered by each individual business. These rewards programs may offer points or other similar rewards that may be accrued by a user, and the user may exchange the points for goods or services, for example. Because many merchants and businesses may offer their own rewards or loyalty program, a single consumer may be a part of, for example, 5-30 different rewards programs. It can become difficult for a user of such programs to manage and track their customer reward points from the various rewards and loyalty programs. Some users may lose track of their earned points, which could expire if unused, and thus go to waste. Some rewards programs may also offer other kinds of benefits instead of or in addition to points, and a user may not be aware of all benefits available to them, or may be unable to track all of their available benefits. Additionally, some goods or services that are available to a user via the rewards points may not be needed by the user, who instead may wish to be able to use their rewards points for another purpose. Some users may also sell their loyalty rewards such as frequent flyer miles and free or discounted hotel stays on the open market to other users. However, this can be a difficult and time-consuming process. Similarly, it may be difficult and costly for merchants to maintain, advertise, and maintain their rewards programs. Merchants offering rewards or loyalty programs may also have other problems, such as smaller businesses being unable to compete with larger businesses.

An example of a system wherein rewards are offered to customers is crowdfunding. Crowdfunding websites may allow for a customer or “backer” to donate or send money to a campaign, and receive a reward in return. However, such platforms may be unable to capture data or offer a reward to a backer who refers another backer to the campaign. Another problem is that rewards promised to backers could go unfulfilled, and it may be difficult for backers to resolve this issue. Another problem is that these platforms may not be capable of rewarding a backer who supports multiple campaigns for a particular length of time; thus, these backers cannot be rewarded for the support of multiple campaigns, for being a frequent backer, or for supporting campaigns for a predetermined amount of time.

Thus, there is a need for a solution to the above problems.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a reward management system and a global e-commerce network are combined, wherein a marketplace is provided for various merchants, retailers, and consumers, and wherein any number of participants may utilize a universal rewards system and make transactions or fund crowdfunding campaigns within a single marketplace using currency, or points and bonus points accrued via the universal rewards system, and wherein the information related to transactions that take place within the reward management system and the global e-commerce network is secured and safely stored in an isolated data storage system that stores the information in flash drives, wherein the flash drives receive the information, and are next autonomously moved from a computer connected to the global e-commerce network to an isolated offline computer via autonomous robotic arms. Thus, an advantage is the need for users to manage and track multiple rewards systems from multiple vendors may be diminished or eliminated. Another advantage is that a single rewards system may save time for users who need to manage only a single rewards system. Another advantage is that a user may earn capital from the selling of rewards points through the reward management system. Another advantage may be that the blockchain technology reduces the risk of users' data being stolen. Another advantage may be that the isolated data storage system may reduce or eliminate the risk of users' data being stolen. Another advantage may be that sponsors of crowdfunding campaigns may be able to offer a wider variety of rewards to backers of campaigns.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIGS. 1A-1C illustrate examples of a diagrammatic view of a universal system for managing rewards, used with a crowdfunding campaign, according to an aspect.

FIGS. 2A-2B illustrate examples of a diagrammatic view of isolated data storage working with autonomous robotic offline data storage, according to an aspect.

FIGS. 3A-3C illustrate examples of a diagrammatic view of a blockchain network using blockchains in a juxtaposed formation and an amalgamated formation, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

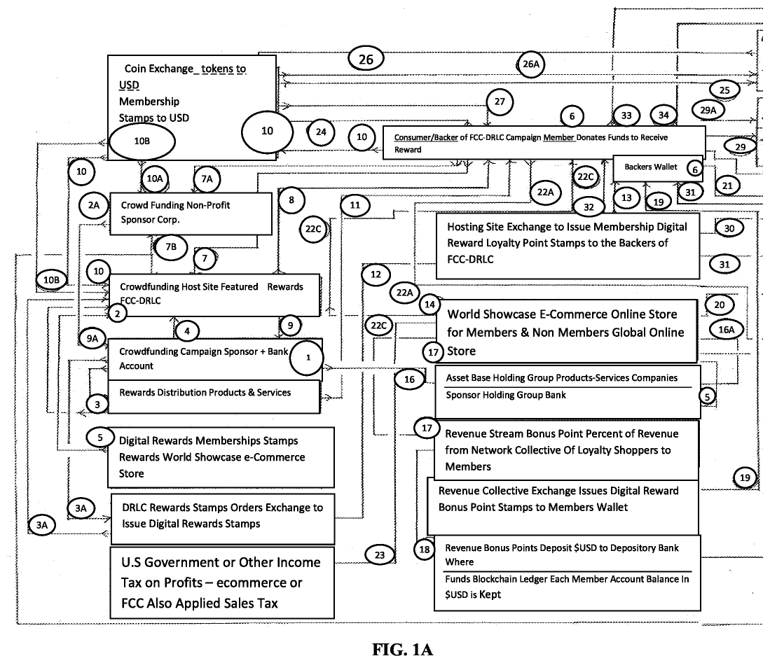

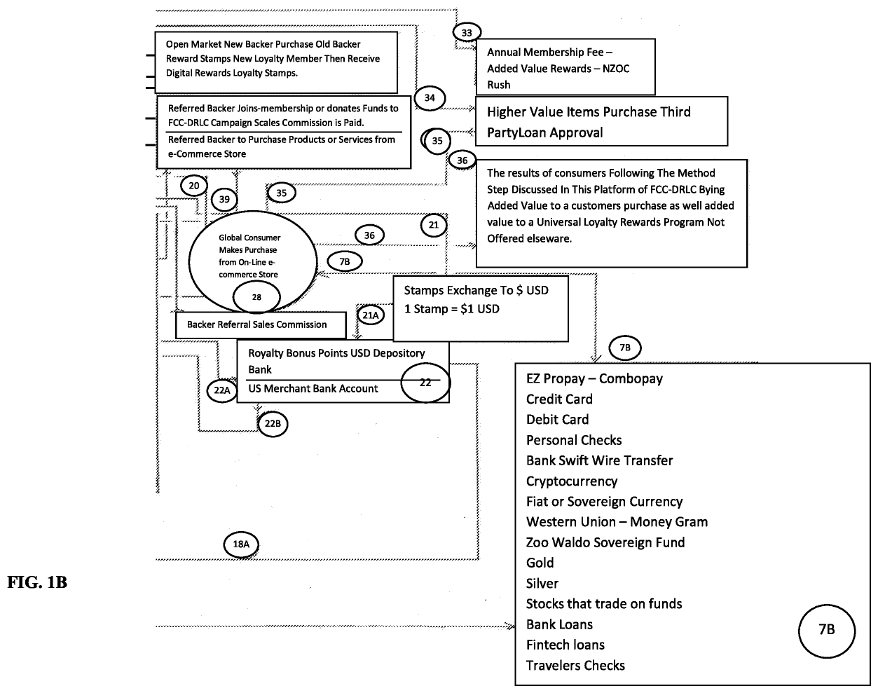

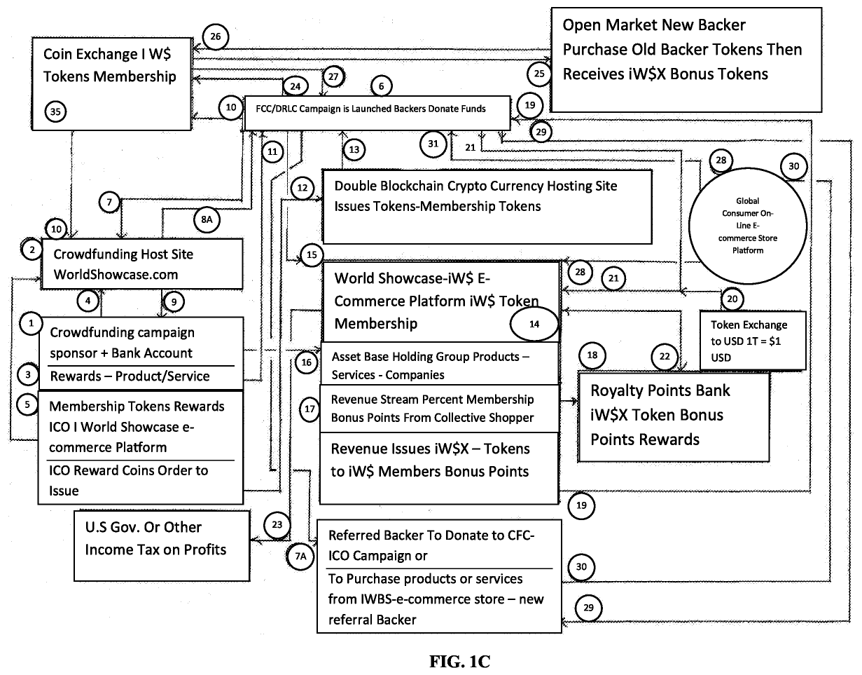

FIGS. 1A-1C illustrate examples of a diagrammatic view of a universal system for managing rewards (“system for managing customer rewards,” “global reward management system,” “universal reward management system,” “reward management system,” or “system”), used with a crowdfunding campaign, according to an aspect. As an example, the reward management system may be used for managing a universal rewards program in which various merchants may participate, such as a global e-commerce network, such that merchants and patrons of the merchants alike may engage in a single marketplace using a single rewards program having a single, universal points currency. As another example, the reward management system may be used with crowdfunding campaigns. The reward management system may make use of blockchain technology. As an example, the reward management system may use multiple blockchains advancing data into a unique blockchain. As may be known in the art, a blockchain, being a continuously growing list of records referred to as blocks, may be linked and secured using cryptography, wherein each block may typically contain a data structure known as a hash pointer used for linking to a group of information (such as a timestamp and transaction data). Blockchain technology may be used for the reward management system and may be used for the purchase of products, services, or memberships within an e-commerce marketplace that utilizes the reward management system. As an example, the reward management system may use a single currency or points system, which may be referred to as digital stamps. Bonus points may also be earned through the reward management system, and may be referred to as bonus point digital stamps.

As shown as an example in FIG. 1A, wherein arrows represent flows of information, a crowdfunding campaign may utilize the reward management system, and a campaign may be referred to as a “featured crowdfunding campaign” by a sponsor of the campaign and may have an established bank account for receiving funds, for example (as shown by 1). The sponsor may have the capability to select from a number of host sites for their featured crowdfunding campaign. The sponsor may advertise the campaign by, for example, creating a white paper, and the information about the campaign may be distributed on the host site (shown by 4).

The sponsor may also have the capability to offer rewards to supporters (which may be referred to as “backers”) of the campaign via the reward management system (shown by 2). The sponsor may also have the capability to offer a reward to a backer who supports multiple campaigns. As an example, the crowdfunding host site may be non-profit and may be hosted by a non-profit sponsor corporation or company (shown by 2A). A backer may donate funds to a featured crowdfunding campaign, or a loyalty campaign (“loyalty campaign” or “digital rewards loyalty campaign”) sponsored by the host site. The sponsor may then distribute rewards, which may be products or services, to the backers (shown by 3). Rewards may be in the form of digital stamps (shown by 3A). An advantage may be that a sponsor no longer needs to ship a physical product as a reward. Backers may also have the opportunity for a membership to the reward management system (shown by 5). Rewards may also be goods or services offered through the e-commerce network. Thus, a backer, who may also be a “member,” may donate funds to a campaign or multiple campaigns to receive rewards (shown by 6).

The funding by a backer may be via the host site (shown by 7). Again, as an example, the campaign could also be a non-profit campaign (shown by 7A). The backer may also access the campaign via a mobile application (shown by 8), which may allow access to a digital wallet. The hosting site (which may be a non-profit hosting site, shown by 9A) may send funds from the backer to the sponsor's established bank account (shown by 9). The backer may use a cryptocurrency as donated funds (shown by 10) to the campaign, or to a non-profit (shown by 10A).

Again as previously discussed, rewards, which may be products or services, may be distributed to the backer (shown by 11). The sponsor may carry this out by issuing an order via the reward management system, and thus place an order through a blockchain marketplace (which may be a “blockchain stamp marketplace”) in order to issue membership digital stamps to backers (shown by 12). The blockchain stamp marketplace may then issue the membership digital stamps to the backers (shown by 13). As an example, an e-commerce store (which may be referred to as an “e-commerce global store,” “e-commerce network,” or “decentralized network collective of merchants”), which may be globally access by various users, may be an online store for members of the reward management system and non-members alike (shown by 14). Merchants and retailers may pay small transaction sales referral fees to the e-commerce global store (shown by 15).

The sponsor may purchase the intellectual property (IP) products or companies that are generating or will be generating revenue and sales, and may place them in a holding group platform (shown by 16). These sponsor-purchased revenue assets may be added to the retailers and merchants accessible through the e-commerce global store (shown by 16A).

A percentage of the revenue from the net collective of shoppers buying from the e-commerce global store may generate a royalty (shown by 17).

Bonus points (which may be referred to as e-commerce bonus points) that are generated within the e-commerce global store may be deposited into a bank for members, which may be referred to as a depository bank for members (shown by 18). E-commerce bonus points may exist as funds, and such funds may be wired to the e-commerce depository bank for members (shown by 18A).

The system for generation of bonus points from the e-commerce global site may be referred to as a revenue collective bonus points exchange. The exchange may issue membership digital stamps to a member's wallet (shown by 19).

A user may also be a member of the e-commerce global store or the e-commerce network. An e-commerce member may initiate a purchase request for a product or service offered through the e-commerce network (shown by 20). In order to complete the purchase, the e-commerce member or backer may send their owned bonus point stamps to a digital stamp exchange to convert their stamps into currency, such as US dollars (shown by 21). Stamps that are converted into dollars may then be sent to the depository bank for members (shown by 21A).

Bonus points that are generated by sales commission royalties may also be converted into currency such as US dollars, and this may also be sent to the e-commerce member bank and may be recorded to a specific member or user's bank holding account (shown by 22).

If a user does not have sufficient stamps for covering the cost of a desired purchase, the user may send credit card funds to the system (shown by 22A). Next, the merchant bank of the e-commerce global store may confirm that payment has been made, and send instructions for shipment of merchandise or fulfillment of goods or services to the user (shown by 22B). Next, the items may be shipped or other suitable fulfillment of the purchase may take place (shown by 22C). Profits that are generated by the e-commerce store may be used for the payment of income taxes or sales taxes where applicable, or any other applicable taxes or fees, such as to a government agency, as an example (shown by 23).

As an example, if a user requires capital, they may sell their membership digital stamps through a stamp exchange, via the reward management system (shown by 24), which may host a stamp exchange marketplace. The stamp exchange marketplace may allow for the selling and bidding on of digital stamps in an open market auction (shown by 26). A new user may be guided within the stamp exchange marketplace on how to open a wallet. The user may make a purchase of membership stamps, and next begin to earn bonus point digital stamps (shown by 26A). A user who sells their stamps within the stamp exchange marketplace may be sent payment by the stamp exchange marketplace (shown by 27). A user may also exchange their digital stamps for currency within the marketplace, for example.

Again as previously discussed, a user may purchase products and services via the e-commerce network (shown by 28). A user, who, again, may be a member of the e-commerce network, may refer or influence another user to purchase products or services from the e-commerce store, and as a result, may receive a sales commission for the referral sale (shown by 29). The sales commission may be in the form of digital stamps. Similarly, a user, who, again, may be a member of the e-commerce network, may refer or influence another user to purchase digital stamps from the stamp exchange marketplace, and as a result, may receive a sales commission for the referral sale (shown by 29A).

Newly referred users who became members of the e-commerce network may purchase goods and services from the e-commerce store, and membership digital stamps from the stamp exchange marketplace, and may then begin to receive membership benefits, as existing members already do (shown by 30). The stamp exchange marketplace may also instruct new members on how to obtain a wallet, which may be used for receive their digital stamps (shown by 31). Next, after the newly referred member completes a purchase or transaction, the referring member may receive sales commissions, which, again, may be in the form of digital stamps (shown by 32).

As an example, an annual membership fee may be required or optional for users for membership to the e-commerce network, and may give additional benefits to members (shown by 33). Members of the e-commerce network may also receive other benefits. For example, a member could receive bonus rewards points when other members shop within the e-commerce network. As another example of a benefit, a user may be able to use a discount when redeeming goods or services using digital stamps. For example, the discount could be 20%, and thus, a user may be capable of purchasing an item valued at $100 for $80 when using their digital stamps. A user may also be capable of purchasing an item at a net zero cost if they have accrued sufficient digital stamps to cover the cost of an item in the e-commerce network. As another example, as was previously discussed, a user may also be awarded additional bonus reward points as a reward currency when shopping in the e-commerce network. Thus, a user who has accumulated sufficient digital rewards points may be capable of shopping via the points, and selling their points. An advantage may be that a wide variety of merchants may accept the digital rewards within the e-commerce network.

As an example, a user may purchase high-value items with a loan approval from a third party, which may be conducted via the reward management system (shown by 34). Loan funds from the third party may be sent to the e-commerce store in order to pay for a user's purchase (shown by 35).

The reward management system shown and described herein may thus add value to consumers' purchases by the generation of bonus points and rewards points, and may also be advantageous for users by diminishing or eliminating the need for tracking multiple rewards programs (shown by 36).

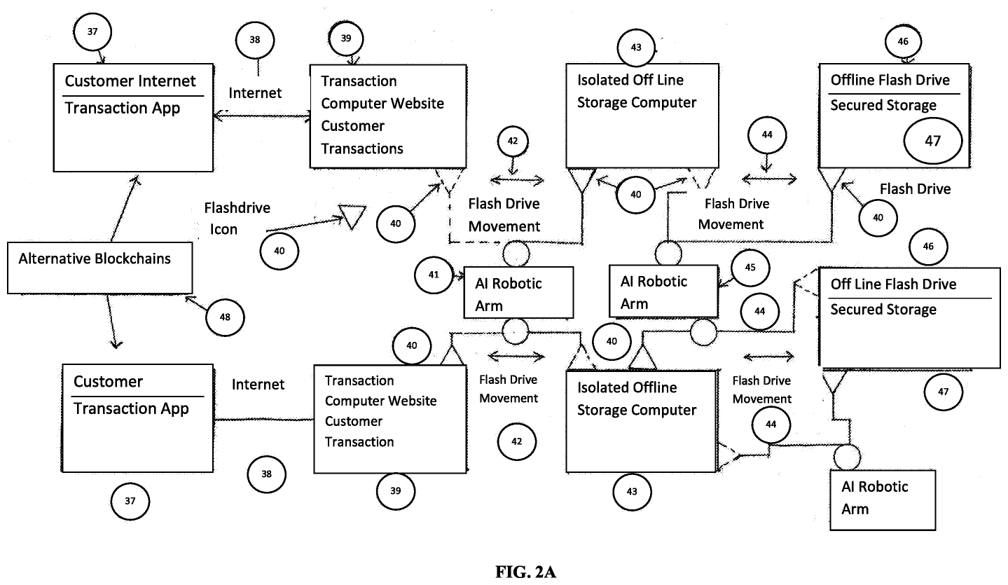

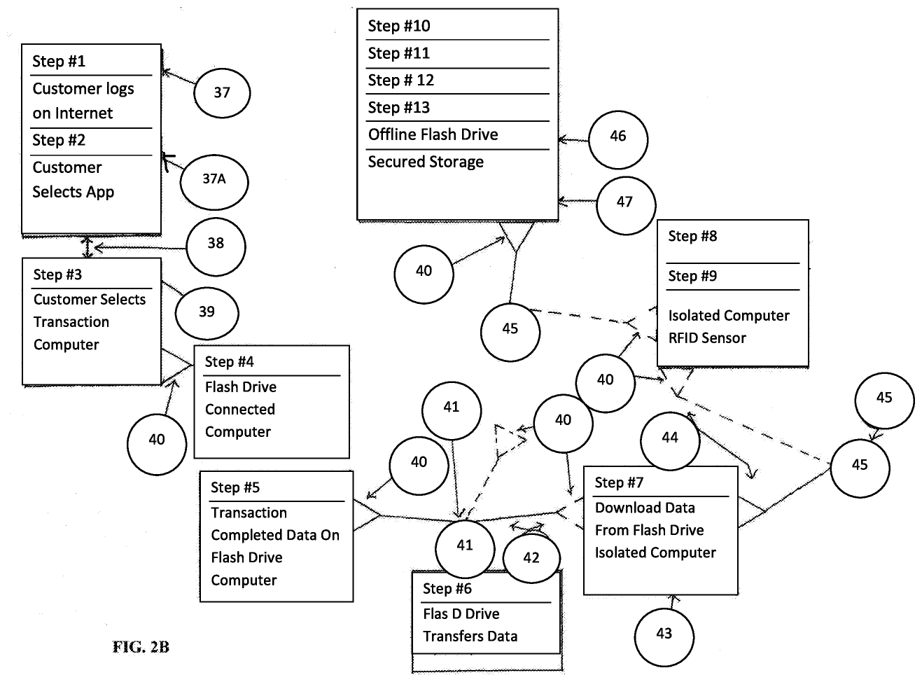

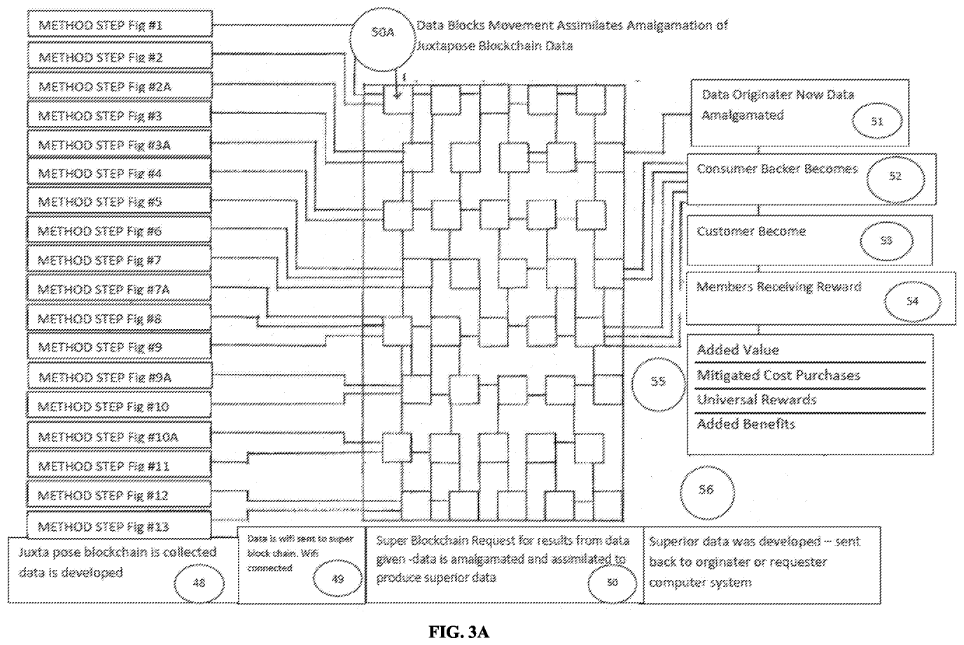

FIGS. 2A-2B illustrate examples of a diagrammatic view of isolated data storage working with autonomous robotic offline data storage, according to an aspect. As shown as an example, a system for isolated security data storage (“isolated data storage system,” “isolated security data storage,” or “isolated security data storage and autonomous robotic offline data storage,”) may be used with the reward management system shown and described when referring to FIGS. 1A-1B. The isolated data storage system may also be used for any suitable commerce or transaction or information relaying performed or carried out online, for example. The isolated data storage system may thus enhance the security of users' information when using, navigating, and carrying out transactions within the reward management system and the e-commerce store shown and described when referring to FIGS. 1A-1B.

As an example, two alternate blockchains representing two transactions are shown by FIG. 2A. In each, a user, who may be a customer, may first make a connection to an e-commerce store via their mobile device, computer, or any other suitable electronic device. The connection may be made via an application on the electronic device (shown by 37). The user may be connected to the e-commerce store via an internet connection (shown by 38). Next, the user may make selections within the application and provide product selection information and payment information (which may be referred to as transaction data). The transaction data may not be downloaded to the e-commerce store's computers, which may be hard drives. The transaction data may similarly not be uploaded into a cloud (shown by 39). The transaction data may be downloaded to a flash drive (shown by 40) which may physically be removed and moved to an isolated computer, thus moving the transaction data offline (shown by 42). An autonomous robotic gripper arm (“autonomous robotic arm,” or “robotic arm”) shown by 41) may be used for the removal and moving of the flash drive. Once moved to the isolated storage computer (shown by 43), the transaction data can be stored on the isolated storage data from the flash drive. The information carried by the flash drive may be stored in an offline, secured identifier capsule, which may have an RFID or any other suitable electronic tag locator or make use of any other suitable locator system such that the robotic arm 41 may be able to locate any particular flash drive related to a specific user's cryptic, secure code ID.

Again as previous discussed, the robotic arm 41 may remove the flash drive from a mainframe computer (shown by 43) to offline secured storage (shown by 46 and 47). The offline secured storage 47 may be secured storage racks, which may be capsules having an automated door capable of opening and closing to allow the robotic arm access. As an example, electronic tag locators may be used, and they may also monitor which user's data is associated with which flash drive, and the capsule that the particular flash drive is stored in. Additional robotic arms (shown by 45) may also be used as needed for the movements of the flash drives.

The offline secured storage area for physical storage of flash drives (shown by 46) may have clean storage capsules which, again, may be provided with electronic locator tags or RFID tags, or, again, any other suitable locator system.

As an example, the steps shown and described when referring to FIG. 2 may also be performed in reverse, such that a flash drive may be used for collecting data from a user's subsequent purchases.

The isolated data storage system may be used for a transaction by carrying out the following exemplary process.

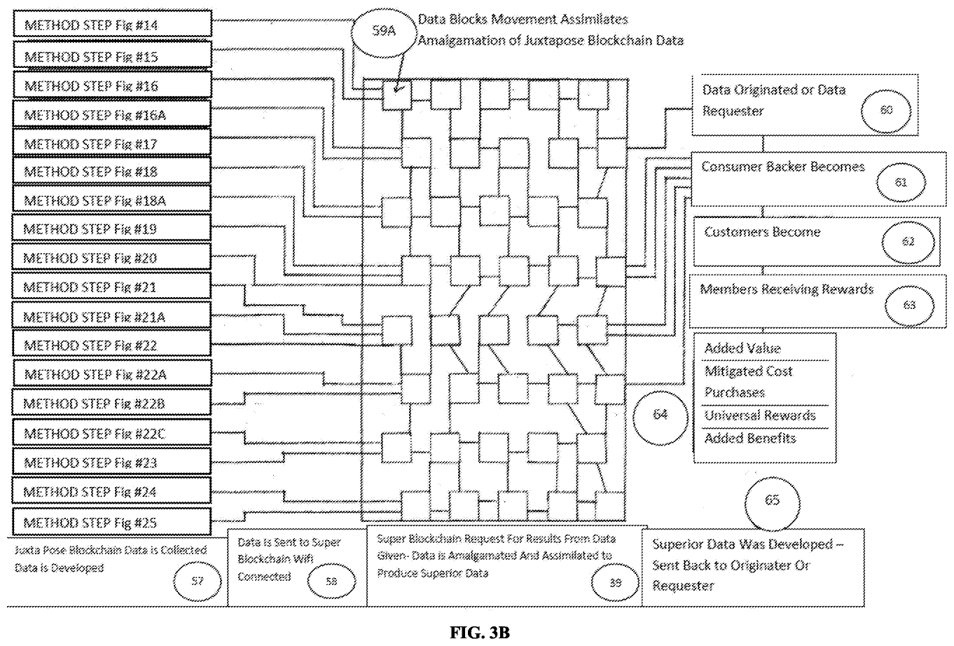

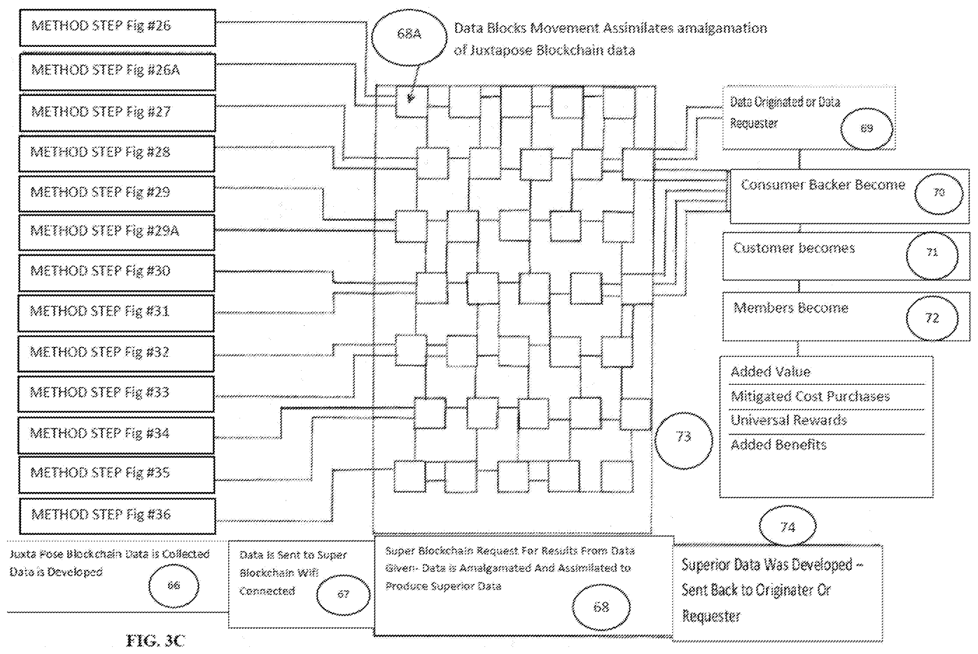

FIGS. 3A-3C illustrate examples of a diagrammatic view of a blockchain network using blockchains in a juxtaposed formation and an amalgamated formation, according to an aspect. A blockchain network as is known in the art may be used for the relaying of information within an e-commerce network and a reward management system, for example. Again as previously discussed, a blockchain may be a continuously growing list of records known as blocks, which may be linked and secured using cryptography, as is known in the art. Each block may typically contain a high pointer as a link to a previous block, a timestamp, and transaction data, as is known in the art. As an example, each step in the process of carrying out a transaction in the e-commerce store as shown and described herein, may have its own blockchain of records of data, which may include timestamps and transaction data. Each blockchain may be capable of processing more than one million transactions per second. Again as was previously discussed, and as is known in the art, blockchains may be inherently resistant to modification of data. Thus, an advantage may be that security may be enhanced for the users of the e-commerce network and reward management system.

Juxtaposed blockchains (shown by 48) may be used to target separate transactions and may help to increase security and anonymity of the users of the e-commerce network and reward management system. Juxtaposed blockchains may process data that are related, but separate from each other for data protection from hackers. This data may be data such as the transaction data generated during transactions (shown by 48, 57, and 66) until the data is sent to become amalgamated (shown by 49, 58, and 67). The amalgamated data may be referred to as a “super blockchain,” (shown by 50, 50A, 59, 59A, 68, and 68A). This may be performed via a Wi-Fi connection, for example, from the juxtaposed blockchain computer system into the super blockchain computer system. Within the super blockchain, the data may be moving more than one million transactions a second. As represented by 50A as an example, data blocks of information in the super blockchain may include information such as the number of digital rewards being issued by a certain crowdfunding campaign, the number of backers contributing a particular amount of funds, or the physical origin of funds, and the location of the highest number of backers. It should be understood that these examples and any other suitable examples of information that may be transmitted or relayed could also be relayed in other steps or aspects of the e-commerce network and reward management system. Next, the amalgamated data can once again become juxtaposed when it is outputted, which again could be through a Wi-Fi connection, and which could be outputted back to the originator of the data, or to any other suitable requester of the data (shown by 56, 65, and 74), for example. It should also be understood that the transaction data or any other suitable data that is outputted may be stored offline in an isolated data storage system, as shown and described when referring to FIGS. 2A-2B.

FIG. 3A shows that the data relayed from the process shown and described by 1-13 of FIG. 1A may be transmitted and secured by using a juxtaposed and amalgamated blockchain formation, for example. FIG. 3B shows that the data relayed from the process shown and described by 14-25 of FIG. 1A may be transmitted and secured by using a juxtaposed and amalgamated blockchain formation, for example. FIG. 3C shows that the data relayed from the process shown and described by 26-36 of FIG. 1A may be transmitted and secured by using a juxtaposed and amalgamated blockchain formation, for example.

Data that may be secured and transmitted using the juxtaposed and amalgamated blockchain formation shown as examples in FIGS. 3A-3C may include data related to events, e-commerce, inventory control, shipping, medical records, medical treatment, management activities, customer identity management, transaction processing, documenting provenance, food traceability, rewards tracking, and rewards redemption.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A reward management system as described herein.
